(19) United States
(12) Patent Application Publication
(10) Pub. No.: US 2024/0029399 A1
(43) Pub. Date: Jan. 25, 2024

(54) IMAGE RECOGNITION SUPPORT APPARATUS AND IMAGE RECOGNITION SUPPORT METHOD

(71) Applicant: HITACHI, LTD., Tokyo (JP)

(72) Inventors: Soichiro OKAZAKI, Tokyo (JP); Yuki WATANABE, Tokyo (JP); Tomoaki YOSHINAGA, Tokyo (JP)

(21) Appl. No.: 18/335,825

(22) Filed: Jun. 15, 2023

(30) Foreign Application Priority Data
Jul. 20, 2022 (JP) 2022-115870

(51) Int. Cl. G06V 10/762; G06T 7/70; G06V 10/74; G06V 10/764

(52) U.S. Cl. CPC G06V 10/762; G06T 7/70; G06V 10/761; G06V 10/764; G06V 2201/07

(57) ABSTRACT

An image recognition support apparatus includes: an image acquisition unit that acquires an image; an image recognition unit that detects an object included in the image using an object detection model; and a detection result processing unit that generates one or more expanded image queries indicating a partial image of the image including the object, and sets a combination having a high similarity calculated using an image language model trained on a relationship between an image and an attribute including a state or situation among combinations of an expanded image query and an expanded language query indicating one or more language labels, as a detected object and an attribute detail label of the object.

### CROSS-REFERENCE TO RELATED APPLICATIONS

This application claims benefit of priority from Japanese Patent Application JP2022-115870, filed Jul. 20, 2022, the contents of both of which are incorporated herein by reference.

### BACKGROUND OF THE INVENTION

### 1. Field of the Invention

The present invention relates to an image recognition support apparatus and an image recognition support method for giving an attribute to an object included in an image.

### 2. Description of the Related Art

Aerial images and satellite images are effective means for remotely grasping the on-site state. For example, a disaster situation can be grasped from the aerial images or the satellite images of a disaster site.

As a method for displaying images (the aerial images) transmitted from a plurality of flight vehicles, there is an information display method described in JP 2019-195174 A. This display method is intended to optimize display of information including a plurality of images, a display region for images transmitted from the flight vehicles is generated, and an image from a flight vehicle selected by a user is displayed in a main region of the display region. In addition, an image in which a predetermined object is detected is displayed in the main region.

### SUMMARY OF THE INVENTION

JP 2019-195174 A does not describe in detail a method of displaying a detected object. For example, if it is possible to detect a state or situation (for example, isolated or submerged) of a recognition object (for example, a person or a house) included in a captured image of the disaster site, it is possible to support relief work for disaster victims.

In order to perform detection, it is necessary to prepare a classifier (machine learning model) that recognizes and classifies the recognition object included in the image. In order to create such a classifier, it is necessary to prepare a pair of an image of an object to be recognized and a label (correct answer label) indicating the object as learning data and cause the classifier to learn (train) the learning data as a pattern. By using such a classifier, it is possible to detect the recognition object in the image and give the label.

After the object to be recognized is detected, it is necessary to detect a detailed state (for example, submerged, collapsed, a state of fire disaster, or the like) of the object in order to further grasp the state or situation of the object. In addition, when appearance of the recognition object changes in the entire image, it is desirable to change the display. For example, when the image changes from a micro viewpoint to a macro viewpoint, it is desirable to switch from “person” to “crowd” for display, or to add “dangerous state” for display.

However, in order to detect the state or situation of the object as described above, it is difficult to prepare the correct answer label indicating the state or situation. Even if a label of a general attribute (for example, “building”, “person”, “car”, and the like) of the object to be recognized can be prepared as the learning data, it is difficult to prepare all labels (for example, “broken”, “submerged”, “fallen”, “buried in soil”, and the like) for detailing the object in advance as the learning data. In addition, there is a demand for eliminating manual setting of conditions for changing display according to a change in the appearance of the recognition target, such as the size and the number of recognition objects in the image.

The present invention has been made in view of such background, and an object of the present invention is to provide an image recognition support apparatus and an image recognition support method for detecting the state or situation of the object included in the image.

In order to solve the above problems, an image recognition support apparatus according to the present invention includes: an image acquisition unit that acquires an image; an image recognition unit that detects an object included in the image using an object detection model; and a detection result processing unit that generates one or more expanded image queries indicating a partial image of the image including the object, acquires a combination having a high similarity calculated using an image language model trained on a relationship between an image and an attribute including a state or situation among combinations of an expanded image query and an expanded language query indicating one or more language labels, and sets the object indicated by the expanded image query of the combination as a detected object and sets the expanded language query of the combination as an attribute detail label of the object.

According to the present invention, it is possible to provide an image recognition support apparatus and an image recognition support method for detecting a state or situation of an object included in an image. Problems, configurations, and effects other than those described above will be clarified by the following description of embodiments.

### BRIEF DESCRIPTION OF THE DRAWINGS

FIG. 1 is a functional block diagram of an image recognition support apparatus according to the present embodiment;

FIG. 2 is a data configuration diagram of an image database according to the present embodiment;

FIG. 3 is a data configuration diagram of a display switching label according to the present embodiment;

FIG. 4 is a data configuration diagram of an attribute detail label according to the present embodiment;

FIG. 5 is a diagram for explaining acquisition processing of the attribute detail label according to the present embodiment;

FIG. 6 is a flowchart of image recognition support processing according to the present embodiment;

FIG. 7 is a flowchart of attribute detail label display processing according to the present embodiment;

FIG. 8 is a flowchart of display switching label display processing according to the present embodiment;

FIG. 9 is a screen configuration diagram of an image recognition result display screen according to the present embodiment;

FIG. 10 is a screen configuration diagram of an expanded query display screen according to the present embodiment;

FIG. 11 is a diagram illustrating the image recognition result display screen in which a region is specified according to the present embodiment; and

FIG. 12 is a diagram illustrating the image recognition result display screen that displays a recognition result of a group of objects according to the present embodiment.

### DESCRIPTION OF THE PREFERRED EMBODIMENTS

Hereinafter, an image recognition support apparatus in a form (an embodiment) for carrying out the present invention will be described. The image recognition support apparatus acquires, for example, an image of a disaster site captured by a camera mounted on a drone, and detects an object such as a person or a house captured in the image using an object detection model. Next, the image recognition support apparatus detects an attribute (for example, an attribute “collapsed” for the house) of the object detected using an attribute classification model.

Subsequently, the image recognition support apparatus generates a partial image (an expanded image query) including the object, and a language label (an expanded language query) such as a synonym of the attribute, a set attribute, and a word specified by a user. The image recognition support apparatus acquires a combination having a high similarity calculated by an image language model among combinations of the expanded image query and the expanded language query, and sets the expanded language query as an attribute detail label of the object. The image recognition support apparatus gives the attribute detail label to the object and displays the object. Note that the language label is a label indicated by a language (text). For example, the attribute detail label is a language label that is a text indicating the attribute of the object. Further, an object detection label described later is a language label indicating a common name of the object. The language label may also be simply referred to as a label.

In addition, the image recognition support apparatus acquires a language label having a high similarity with the entire image based on the image language model with respect to a label (language label, text) that is an attribute of a plurality of objects instead of an attribute of each individual object, and gives the language label to the image as a display switching label and displays the image. Language labels that are candidates for the display switching label include “crowd”, “danger (state)”, and the like, and are registered in advance.

According to such an image recognition support apparatus, it is possible to give an attribute detail label indicating a state or situation of the object captured in the image to the object and display the object. Consequently, the user of the image recognition support apparatus can quickly and accurately grasp the situation of the object (for example, the house at the disaster site) at a site captured in the image.

In order to prepare a machine learning model for acquiring the attribute detail label for the object, a large amount of learning data to be a pair of the object and the attribute detail label is required, and it is difficult to prepare such learning data. By generating the expanded image query and the expanded language query and calculating the similarity using the image language model, the attribute detail label for the object can be acquired without preparing a large amount of learning data.

In addition, by displaying the display switching label by the image recognition support apparatus, it is possible to quickly and accurately grasp the situation of the entire site captured in the image.

### <<Configuration of Image Recognition Support Apparatus>>

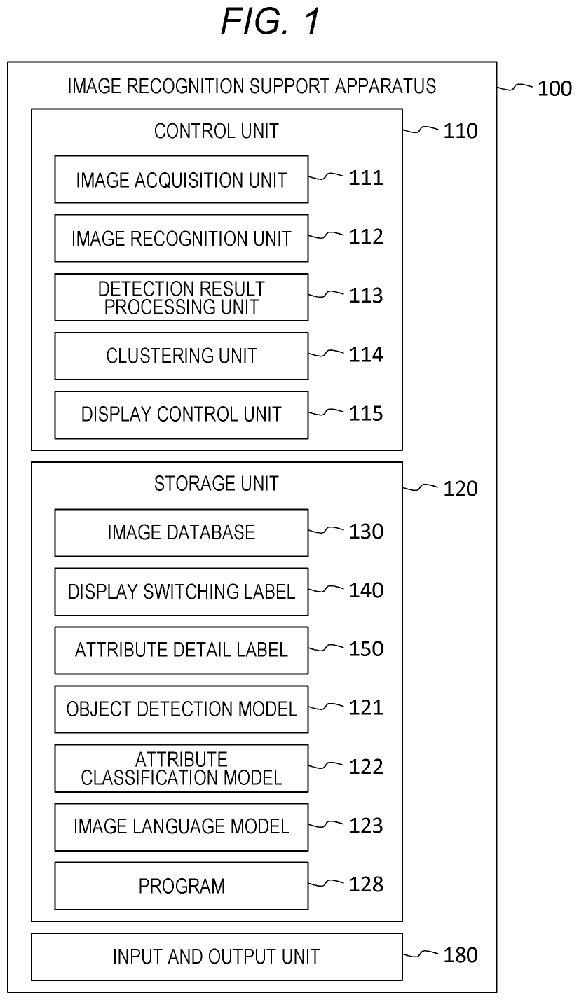

FIG. 1 is a functional block diagram of an image recognition support apparatus 100 according to the present embodiment. The image recognition support apparatus 100 is a computer, and includes a control unit 110, a storage unit 120, and an input and output unit 180. User interface devices such as a display, a keyboard, and a mouse are connected to the input and output unit 180. The input and output unit 180 may include a communication device and be able to transmit and receive data (for example, an image from a monitoring camera or the drone) to and from another device. In addition, a media drive may be connected to the input and output unit 180 so that the data can be exchanged using a recording medium.

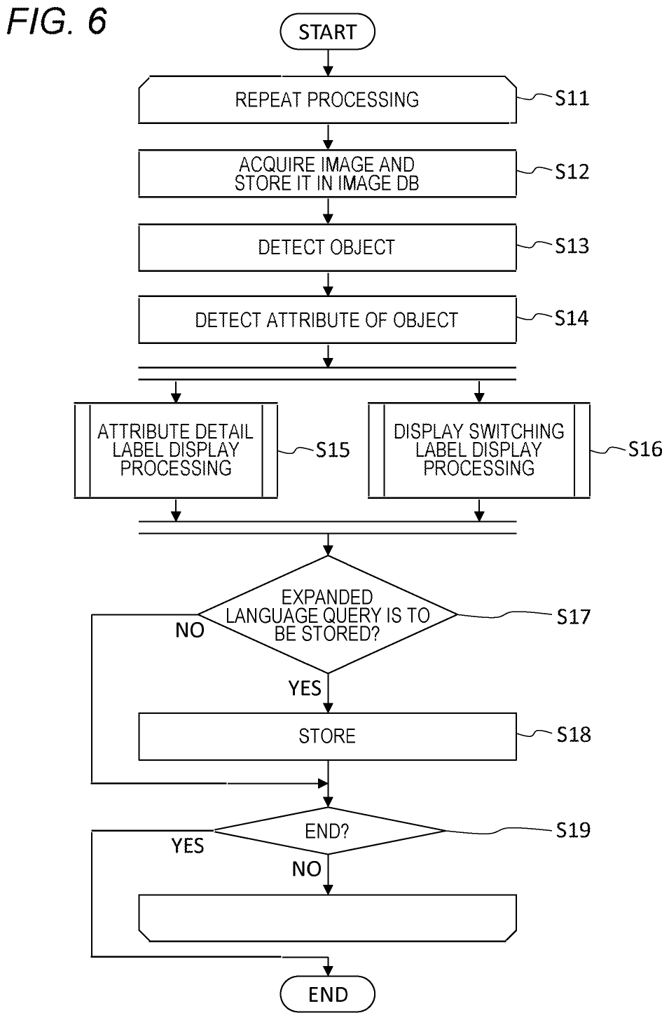

The storage unit 120 includes a storage device such as a read only memory (ROM), a random access memory (RAM), and a solid state drive (SSD). The storage unit 120 stores an image database 130, a display switching label 140, an attribute detail label 150, an object detection model 121, an attribute classification model 122, an image language model 123, and a program 128. The program 128 includes description of a processing procedure in image recognition support processing (see FIG. 6) to be described later.

### <<Storage Unit: Image Database>>

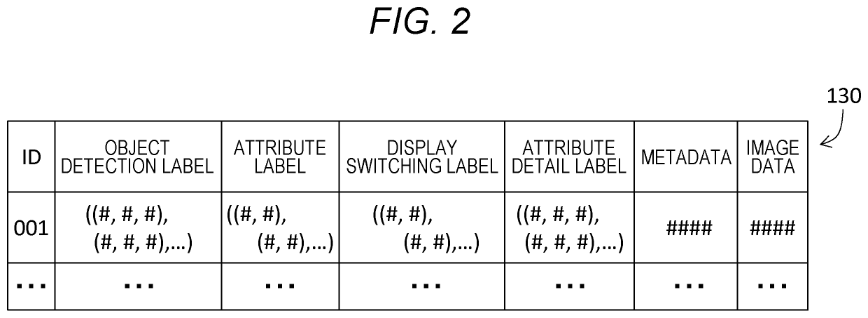

FIG. 2 is a data configuration diagram of the image database 130 according to the present embodiment. The image database 130 is, for example, tabular data, and one row (record) indicates one image. The record includes columns (attributes) of identification information (described as “ID” in FIG. 2), the object detection label, an attribute label, the display switching label, the attribute detail label, metadata, and image data.

The identification information indicates identification information of the image.

The object detection label includes a list of tuples including a position, a label, and a certainty factor of the object captured in the image detected by an image recognition unit 112 to be described later. The position indicates a region in the image in which the object is captured. The label is a label or a language label indicating the common name of the object, and is, for example, “house”, “person”, or the like. The certainty factor is an accuracy or probability that the object captured in the region of the image indicated by the position is the object indicated by the label. Note that in the following description, the label included in the object detection label may be referred to as the object detection label.

The attribute label includes a list of pairs including the position of the object captured in the image and a label indicating the attribute of the object detected by the image recognition unit 112 to be described later. The position is a position (a region) of the object and corresponds to a position included in the object detection label. The attribute is the attribute of the object, and for example, there are attributes such as “collapsed” and “submerged” for the house.

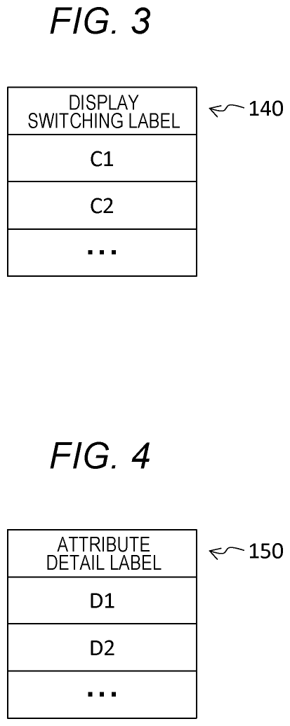

The display switching label includes a list of pairs including a label (display switching label) included in the display switching label 140 (see FIG. 3 to be described later) and similarity between the image and the label calculated using the image language model 123 to be described later.

The attribute detail label includes a list of tuples including the position of the object captured in the image, the label (attribute detail label) included in the attribute detail label 150 (see FIG. 4 to be described later), and the similarity between the image of the object (the image corresponding to the position of the object) and the label calculated using the image language model 123. The label may include the attribute of the object detected by the image recognition unit 112, a synonym of the attribute and the attribute detail label, and the like (see the expanded language query to be described later).

The metadata is metadata of the image, and includes, for example, a shooting date and time, a place, and the like of the image.

The image data is an image itself (data).

### <<Storage Unit: Display Switching Label>>

FIG. 3 is a data configuration diagram of the display switching label 140 according to the present embodiment. The display switching label 140 includes one or more labels (display switching labels). The display switching label is registered (added or deleted) by the user or an administrator of the image recognition support apparatus 100.

The display switching label is a label for the plurality of objects captured in the entire image or the partial image of the image instead of each individual object. As examples of the display switching label, there are labels indicating names of a plurality of persons, such as “crowd”, “crowd of people”, and “group” for an image in which the plurality of persons are captured. As other examples, there are labels indicating states, situations, and attributes of the plurality of persons, such as “dangerous”, “orderly”, and “excited”.

### <<Storage Unit: Attribute Detail Label>>

FIG. 4 is a data configuration diagram of the attribute detail label 150 according to the present embodiment. The attribute detail label 150 includes one or more labels (attribute detail labels). The attribute detail label is registered (added or deleted) by the user or the administrator of the image recognition support apparatus 100.

The attribute detail label is a label for the object. Examples of the attribute detail label include “normal”, “submerged”, and “collapsed” for the house.

### <<Storage Unit: Object Detection Model>>

Returning to FIG. 1, description of the storage unit 120 will be continued. The object detection model 121 is a machine learning model used for processing in which the image recognition unit 112 described later detects the object captured in the image and acquires the position (region) of the object and the label (“person”, “house”, or the like) of the common name. Note that an output of the processing may include the certainty factor in addition to the position and the label. The image recognition unit 112 stores the output in the object detection label of the image database 130 (see FIG. 2). Thus, the label is also the object detection label.

### <<Storage Unit: Attribute Classification Model>>

The attribute classification model 122 is a machine learning model used for processing of acquiring the attribute of the object detected by the image recognition unit 112 described later. Note that an output of the processing may include the certainty factor in addition to the attribute. The image recognition unit 112 stores the output in the attribute label of the image database 130 (see FIG. 2).

Examples of the object to which the attribute is given include “collapsed building”, “submerged building”, “fallen person”, and “car buried in soil”, but it is difficult to prepare learning data of the attribute classification model 122 so as to enable acquisition of such an attribute. Therefore, the attribute acquired using the attribute classification model 122 does not necessarily appropriately indicate the state or situation of the object.

In addition to the attribute acquired using the attribute classification model 122, the image recognition support apparatus 100 acquires an appropriate label indicating the state or situation of the object from among labels included in synonyms of the attribute and the attribute detail label 150 (see FIG. 4) using the image language model 123 to be described later.

Note that there is a deep learning model as one of the object detection model 121 and the attribute classification model 122, which are machine learning models. Examples of such a model include a convolutional neural network (CNN) configured by a network having a plurality of layers, a vision transformer, and the like.

### <<Storage Unit: Image Language Model>>

The image language model 123 is a machine learning model indicating a relationship between the image and the language (text). Examples of the text include “dog photo”, “cute cat”, and “lying dog”. While the object detection model 121 learns a relationship between the image and the label (for example, the common name such as “person” or “house”), the image language model 123 learns a relationship between the image and the attribute including the state or situation. By using the image language model 123, the similarity between the image and the attribute can be calculated, and the attribute having a high similarity to the image can be regarded as indicating the attribute of the image. As an example of the image language model 123, there is a contrastive language-image pre-training (CLIP).

### <<Control Unit>>

Following the storage unit 120, the control unit 110 will be described. The control unit 110 includes a central processing unit (CPU), and includes an image acquisition unit 111, the image recognition unit 112, a detection result processing unit 113, a clustering unit 114, and a display control unit 115.

### <<Control Unit: Image Acquisition Unit>>

The image acquisition unit 111 acquires the image via the input and output unit 180 and stores the image in the image data of the image database 130 (see FIG. 2). Further, when the metadata is given to the image, the metadata is stored in the metadata of the image database 130.

The image may be, for example, an image captured by an imaging device carried by the person or a device fixed to a ground surface. Further, the image may be an image captured by the imaging device provided in a vehicle or the like moving on the ground surface, or an imaging device provided in a drone, an aircraft, a satellite, or the like. The imaging device may be connected to the image recognition support apparatus 100 via a network or may be directly connected to the image recognition support apparatus. Further, the image may be an image or video captured in the past and stored in a recording medium.

As described above, the image recognition support apparatus 100 includes the image acquisition unit 111 that acquires the image.

### <<Control Unit: Image Recognition Unit>>

Using the object detection model 121, the image recognition unit 112 detects an object captured in the acquired image, acquires the position (region), the label (object detection label), and the certainty factor, and stores them in the object detection label of the image database 130 (see FIG. 2). Subsequently, the image recognition unit 112 acquires the attribute (label, language label) of the object (the image of the object indicated by the position) using the attribute classification model 122, and stores the attribute in the attribute label of the image database 130.

As described above, the image recognition support apparatus 100 includes the image recognition unit 112 that detects the object included in the image using the object detection model 121.

The image recognition unit 112 detects the language label indicating the attribute of the object using the attribute classification model 122.

### <<Control Unit: Detection Result Processing Unit>>

The detection result processing unit 113 acquires the display switching label of the image and the attribute detail label of the detected object using the image language model 123.

First, the display switching label will be described. The detection result processing unit 113 calculates a similarity between the image acquired by the image acquisition unit 111 and each of the display switching labels that are labels included in the display switching label 140 (see FIG. 3) using the image language model 123, and stores the similarity in the display switching label of the image database 130 (see FIG. 2). In addition, when an average value of high similarity is a predetermined value or more, the detection result processing unit 113 notifies the display control unit 115 to be described later of the display switching label corresponding to the similarity and instructs the display control unit 115 to display the display switching label. Note that for the average value, refer to description of the average value in the attribute detail label.

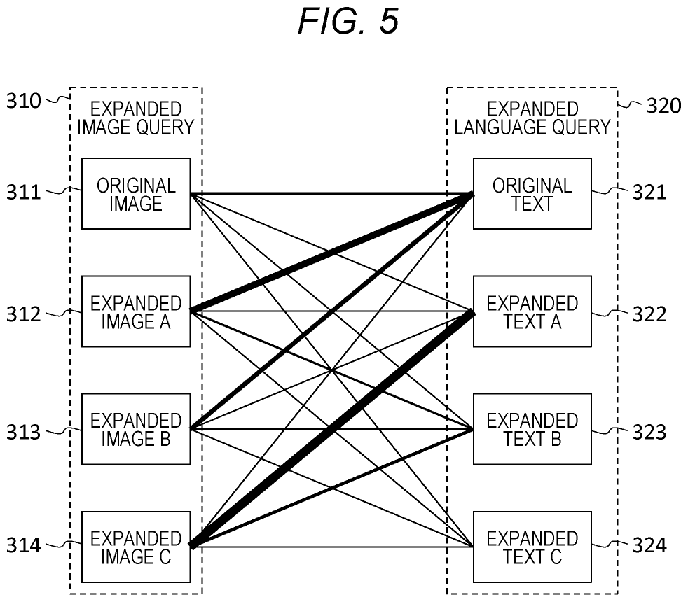

Next, the attribute detail label will be described. FIG. 5 is a diagram for explaining acquisition processing of the attribute detail label according to the present embodiment. An original image 311 is an image of the object detected by the image recognition unit 112. The detection result processing unit 113 generates expanded images 312 to 314 that are images including the original image 311, overlapping the original image 311, or included in the original image 311. Note that FIG. 5 illustrates three expanded images 312 to 314, but the number of the expanded images is not limited to three. Note that the expanded images 312 to 314 including the original image 311 are also referred to as an expanded image query 310.

An original text 321 is an attribute of the object detected by the image recognition unit 112. The detection result processing unit 113 acquires a synonym of the original text 321, extension or addition by these templates, and a label included in the attribute detail label 150, and sets them as expanded texts 322 to 324. The expanded texts 322 to 324 may be an attribute (language label, text) specified by the user.

The template is, for example, a template that gives “a photograph of” such as “a photograph of a collapsed house” or a template that gives “a state of” when an attribute “collapsed” is acquired for the object called a house. Note that FIG. 5 illustrates the three expanded texts 312 to 314, but the number of the expanded texts is not limited to three. Note that the expanded texts 322 to 324 including the original text 321 are also referred to as an expanded language query 320.

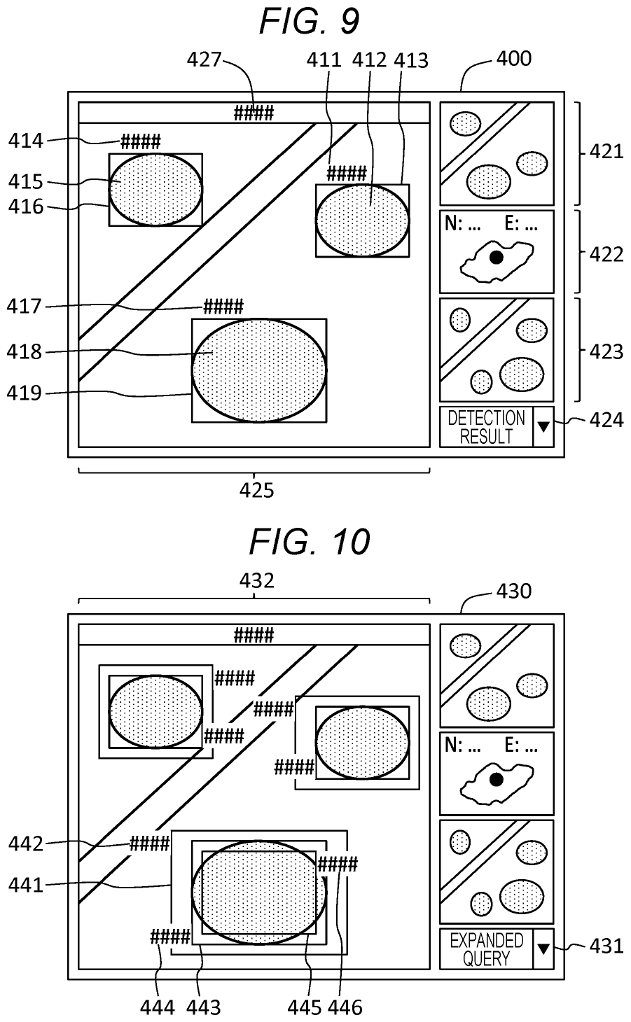

Next, the detection result processing unit 113 generates a combination of the expanded image query 310 (the original image 311 and the expanded images 312 to 314) and the expanded language query 320 (the original text 321 and the expanded texts 322 to 324). Next, the detection result processing unit 113 calculates a similarity of each combination using the image language model 123, and calculates an average of similarity having high predetermined number or predetermined ratio from combinations having a high similarity. Any average such as a geometric average may be used as the average in addition to an arithmetic average. When the average of the similarity is equal to or larger than a predetermined value, the detection result processing unit 113 stores the expanded image query and the expanded language query included in the combination, and the similarity of the combination in the attribute detail label of the image database 130 (see FIG. 2), and notifies the display control unit 115 to be described later of them. The display control unit 115 displays the expanded image query and the expanded language query (see FIG. 9). Note that in FIG. 5, the similarity is indicated by a thickness of a line connecting the expanded image query and the expanded language query. For example, a line connecting the expanded image 314 and the expanded text 322 is the thickest, which indicates that the expanded image 314 and the expanded text 322 have a maximum similarity.

As described above, the image recognition support apparatus 100 includes the detection result processing unit 113 that generates one or more expanded image queries indicating the partial image of the image including the object, acquires the combination having a high similarity calculated using the image language model 123 trained on the relationship between the image and the attribute including the state or situation among the combinations of the expanded image query and the expanded language query indicating one or more language labels, and sets the object indicated by the expanded image query of the combination as the detected object and sets the expanded language query of the combination as the attribute detail label of the object.

The detection result processing unit 113 calculates, as the display switching label of the image, the display switching label having a high similarity calculated using the image language model 123 among combinations of the image and the display switching label (see the display switching label 140) indicating one or more language labels.

The expanded language query includes a preset language label (see the attribute detail label 150) indicating the attribute of the object.

The expanded language query includes at least one of the language label indicating the attribute (of the object) and the language label indicating the synonym of the attribute.

The expanded language query includes the language label specified (by the user).

### <<Control Unit: Clustering Unit and Display Control Unit>>

The clustering unit 114 performs clustering processing of grouping objects included in a specified region in the image by grouping objects at close distances into one group.

The display control unit 115 displays processing results of the image recognition unit 112 and the detection result processing unit 113 on a display connected to the input and output unit 180 as an image recognition result display screen 400 (see FIG. 9 to be described later) or an expanded query display screen 430 (see FIG. 10).

As described above, the image recognition support apparatus 100 includes the clustering unit 114 that performs the clustering processing on the objects included in the specified region in the image and divides the objects at close distances into a plurality of groups.

### <<Image Recognition Support Processing>>

FIG. 6 is a flowchart of the image recognition support processing according to the present embodiment.

In step S11, the image acquisition unit 111 starts processing of repeating steps S12 to S19.

In step S12, the image acquisition unit 111 acquires the image and stores the image in the image database 130 (see FIG. 2, described as image database (DB) in FIG. 6).

In step S13, the image recognition unit 112 detects the object captured in the image using the object detection model 121.

In step S14, the image recognition unit 112 detects (acquires) the attribute of the object detected in step S13 using the attribute classification model 122.

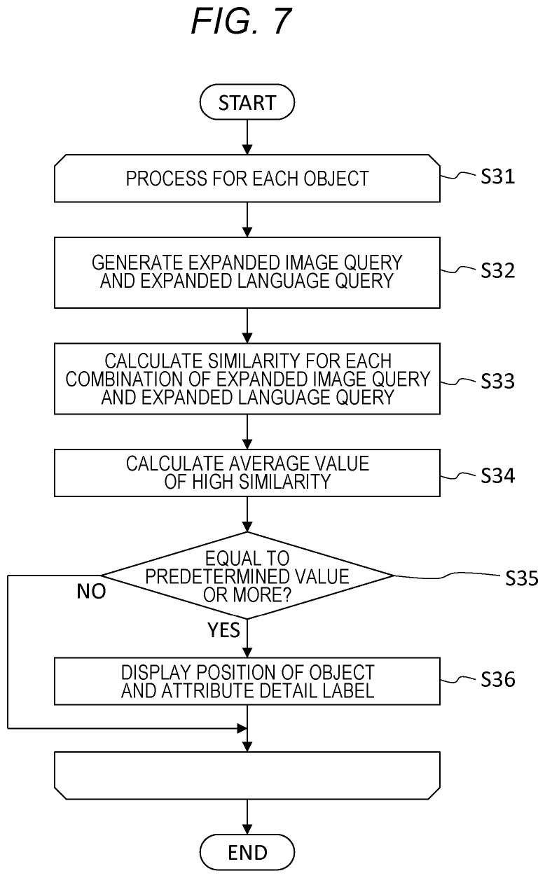

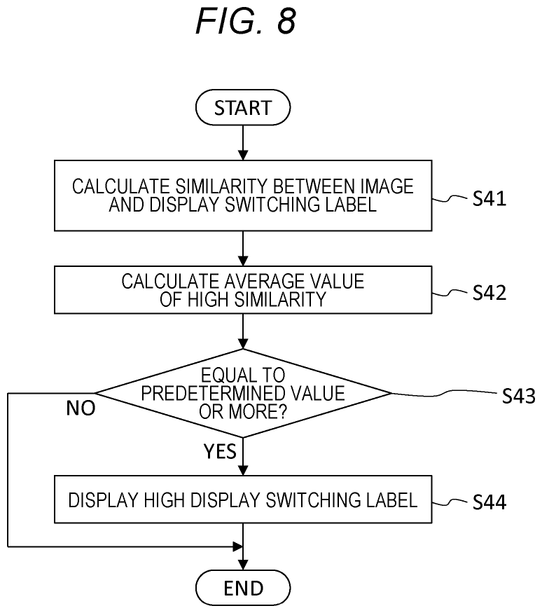

Attribute detail label display processing (see FIG. 7 to be described later) in step S15 and display switching label display processing (see FIG. 8 to be described later) in step S16 are simultaneous parallel processing. Details of steps S15 and S16 will be described later with reference to FIGS. 7 and 8.

In step S17, the detection result processing unit 113 determines whether to store the expanded language query that is not included in the display switching label 140 (see FIG. 3) or the attribute detail label 150 (see FIG. 4). The detection result processing unit 113 proceeds to step S18 in the case of storing (YES in step S17), and proceeds to step S19 in the case of not storing (NO in step S17). Determination procedure will be described together with step S18 described later.

In step S18, the detection result processing unit 113 adds the expanded language query to the display switching label 140 or the attribute detail label 150 and stores the expanded language query. For example, when the expanded language query is the attribute acquired by the image recognition unit 112 or the synonym of the attribute, and an average value of high similarity between the expanded language query and the expanded image query calculated using the image language model 123 is a predetermined value or more (see steps S33 to S35 illustrated in FIG. 7), the detection result processing unit 113 stores the expanded language query in the attribute detail label 150. Further, when a similarity between the label specified by the user and the image calculated using the image language model 123 is a predetermined value or more, the detection result processing unit 113 stores the similarity in the display switching label 140.

In step S19, the image acquisition unit 111 determines whether the process is to be ended, and if the process is to be ended (YES in step S19), the process is ended, and if the process is not to be ended (NO in step S19), the process returns to step S12. For example, if there is no input of the image or if an end menu is selected on the image recognition result display screen 400, the image acquisition unit 111 determines that the process is to be ended.

### <<Attribute Detail Label Display Processing>>

FIG. 7 is a flowchart of the attribute detail label display processing (see step S15 illustrated in FIG. 6) according to the present embodiment.

In step S31, the detection result processing unit 113 starts processing of repeating steps S32 to S36 for each object detected by the image recognition unit 112 in step S13 (see FIG. 6).

In step S32, the detection result processing unit 113 generates the expanded image query and the expanded language query (see FIG. 5).

In step S33, the detection result processing unit 113 calculates the similarity for each combination of the expanded image query and the expanded language query using the image language model 123.

In step S34, the detection result processing unit 113 calculates an average value of similarity having high predetermined number or predetermined ratio among similarities calculated in step S33.

In step S35, if the average value calculated in step S34 is greater than or equal to a predetermined value (YES in step S35), the detection result processing unit 113 proceeds to step S36, and if the average value is less than a predetermined value (NO in step S35), the detection result processing unit 113 returns to step S32 to subsequently process the object.

In step S36, the detection result processing unit 113 instructs the display control unit 115 to display the position (expanded image query) of the object corresponding to the maximum similarity and the expanded language query that is the attribute detail label (see FIG. 9 to be described later).

### <<Display Switching Label Display Processing>>

FIG. 8 is a flowchart of the display switching label display processing (see step S16 illustrated in FIG. 6) according to the present embodiment.

In step S41, the detection result processing unit 113 calculates a similarity between the image acquired in step S12 (see FIG. 6) and each of the labels (display switching labels) included in the display switching label 140 (see FIG. 3) using the image language model 123.

In step S42, the detection result processing unit 113 calculates the average value of similarity having high predetermined number or predetermined ratio among the similarities calculated in step S41.

In step S43, if the average value calculated in step S42 is greater than or equal to a predetermined value (YES in step S43), the detection result processing unit 113 proceeds to step S44, and if the average value is less than a predetermined value (NO in step S43), the process is ended.

In step S44, the detection result processing unit 113 instructs the display control unit 115 to display the display switching label corresponding to high similarity in step S42 (see FIG. 9 to be described later).

### <<Image Recognition Result Display Screen>>

FIG. 9 is a screen configuration diagram of the image recognition result display screen 400 according to the present embodiment. The original image input to the image recognition support apparatus 100 is displayed in an upper right region 421 of the image recognition result display screen 400. A map indicating a shooting position (see a black circle) of the original image is displayed in a middle right region 422 of the image recognition result display screen 400.

An image similar to the original image is displayed in a lower right region 423 of the image recognition result display screen 400. The image similar to the original image is an image capturing an object having an attribute similar to or the same as the attribute of the image or the object captured in the image in a region 425 to be described later. Further, the similar image may be an image having a close shooting position, or may be an image having a similarity (for example, color distribution of pixels) other than the attribute. By referring to the similar image, the user can be made to understand the attribute of the image.

In a pull-down menu 424, “detection result”, “expanded query”, and the like can be selected. The “detection result” is selected on the image recognition result display screen 400 illustrated in FIG. 9, and the detection result of the object captured in the image (original image) is displayed in the region 425 on the left portion of the image recognition result display screen 400.

A display switching label 427 is displayed on the upper portion of the region 425. The display switching label is processing to be displayed corresponding to step S44 of the display switching label display processing (see FIG. 8), and is one or more display switching labels having a high similarity (see steps S42 and S43) to the original image calculated using the image language model 123.

For detected objects 412, 415, and 418, regions 413, 416, and 419 (position, expanded image query) and attribute detail labels 411, 414, and 417 (described as “HO*” in FIG. 9) indicating the object 412, 415, and 418 are respectively displayed. The regions 413, 416, and 419 and the attribute detail labels 411, 414, and 417 are the positions and the attribute detail labels of the objects corresponding to the maximum similarity (see step S36 in FIG. 7). Note that the attribute detail labels 411, 414, and 417 may include the similarity.

With such display, the user of the image recognition support apparatus 100 can easily grasp the image and the state or situation of the objects 412, 415, and 418 captured in the image.

As described above, the image recognition support apparatus 100 includes a display control unit 115 that outputs the image recognition result display screen 400 including an image (see the region 425) indicating the expanded image query and the expanded language query that are a combination having a maximum similarity among the combinations of the expanded image query and the expanded language query related to the object.

### <<Expanded Query Display Screen>>

When the “expanded query” is selected in the pull-down menu 424, the image recognition result display screen 400 is switched to the expanded query display screen 430 (see FIG. 10 described later). FIG. 10 is a screen configuration diagram of the expanded query display screen 430 according to the present embodiment. The “expanded query” is selected in a pull-down menu 431, and the expanded image query and the expanded language query are displayed for the object captured in the image in a region 432 on the left portion of the expanded query display screen 430. The expanded image query and the expanded language query for the object 418 (see FIG. 9) in the lower center will be described below.

Regions 441, 443, and 445 (positions) indicate the expanded image query. Labels 442, 444, and 446 are the expanded language query (attribute detail label, language label) having a high similarity (see step S34 described in FIG. 7) respectively for the regions 441, 443, and 445, and the similarity.

With such display, the user of the image recognition support apparatus 100 can grasp which part of the image (original image) is recognized and how recognized by the image recognition support apparatus 100 for the image and the objects 412, 415, and 418 (see FIG. 9) captured in the image.

As described above, the image recognition support apparatus 100 includes the display control unit 115 that outputs the expanded query display screen 430 including an image (see the region 432) indicating a similarity between the expanded image query and the expanded language query calculated using the expanded image query, the expanded language query, and the image language model 123.

### <<Label Editing Operation>>

The user of the image recognition support apparatus 100 can edit the display switching label 140 (see FIG. 3) and the attribute detail label 150 (see FIG. 4) on the image recognition result display screen 400 or the expanded query display screen 430. More specifically, for example, when “label editing” is selected in the pull-down menu 424 and 431, the detection result processing unit 113 displays an edit screen (not illustrated) of the display switching label 140 and the attribute detail label 150. When an editing end is instructed, the detection result processing unit 113 stores editing results in the display switching label 140 and the attribute detail label 150.

By using such an editing operation, the user can stop unnecessary display switching labels and attribute detail labels, or add a display switching label or an attribute detail label that the user wants to be displayed when the object is detected.

### <<Summarizing Operation>>

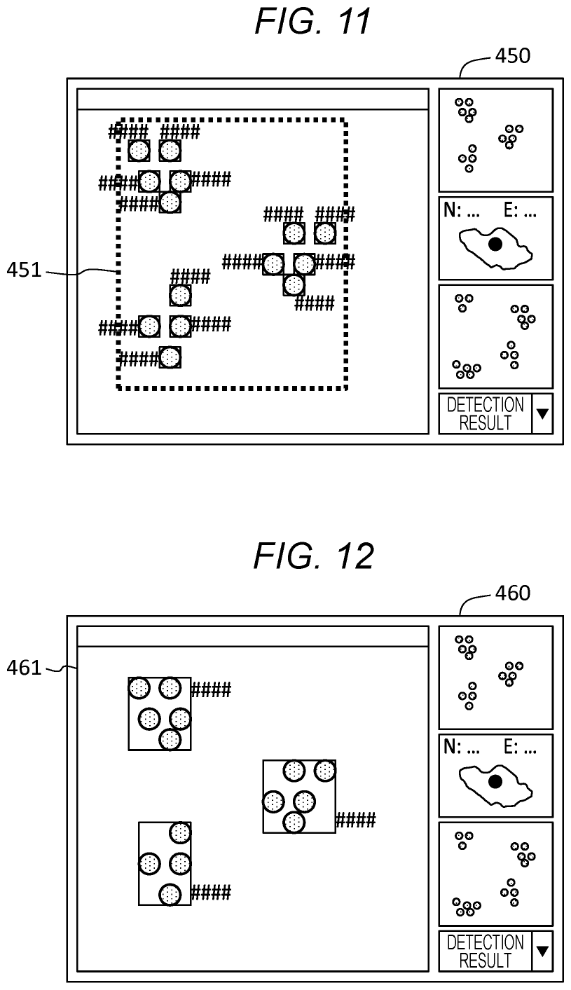

The user of the image recognition support apparatus 100 can acquire a summary result of the object captured in the region by specifying the region of the image on the image recognition result display screen 400. FIG. 11 is a diagram illustrating an image recognition result display screen 450 in which a region 451 is specified according to the present embodiment. On the image recognition result display screen 450, 14 objects (hatched circles) are detected, and the region and the attribute detail label are displayed for each object. Here, it is assumed that the user specifies the region 451 and instructs summarization.

Then, the clustering unit 114 divides the detected objects into groups on the basis of the distance. Next, the objects included in each group are regarded as one object, and processing of steps S14 to S19 (see FIG. 6) is performed. Further, when a position of an object (see step S13) detected in a next image in repetitive processing of FIG. 6 is close to the position of the object when the region 451 is specified (for example, a difference in position is a predetermined value or less), processing from grouping by the clustering unit 114 onward is repeated.

FIG. 12 is a diagram illustrating an image recognition result display screen 460 that displays a recognition result of a group of objects according to the present embodiment. The 14 objects are divided into a group of 5 objects, a group of 5 objects, and a group of 4 objects from the top, and a region indicating a position of each group and the attribute detail label of the group are displayed. Note that processing of detecting (acquiring) the attribute detail label is performed by the detection result processing unit 113 (see the attribute detail label display processing illustrated in FIG. 7).

By using such a summarizing operation, for example, in an image in which the plurality of persons are captured, the user can display a plurality of nearby persons (a group of nearby persons) as a crowd, or acquire a state or situation of the crowd.

As described above, the detection result processing unit 113 regards a group (of objects) as one object, and calculates the group and the attribute detail label of the group.

### <<Features of Image Recognition Support Apparatus>>

The image recognition support apparatus 100 detects the object using the object detection model 121, and then detects the attribute of the detected object using the attribute classification model 122. Subsequently, the image recognition support apparatus 100 generates the expanded image query and the expanded language query, acquires the combination having a high similarity calculated by the image language model 123 among the combinations of the expanded image query and the expanded language query, sets the expanded language query as the attribute detail label of the object, gives (superimposes) the attribute detail label to the object, and displays the object.

The image recognition support apparatus 100 can calculate a more accurate similarity by calculating a similarity of combination of one or more expanded image queries and one or more expanded language queries rather than calculating the similarity by using the original image and the language label. This is because a rectangular image of the object itself is not necessarily optimal as an image indicating the object, and background around the object may contribute as information indicating the object and the state or situation of the object. In addition, as for the language label, the language label specified in advance by the user is not necessarily optimal as a label (text) for indicating the state of the object, and a label converted with the synonym or the template may be appropriate.

When the attribute of the object captured in the image is detected (acquired, described) using the image language model 123, a more accurate and detailed state or situation can be acquired by using the expanded image query and the expanded language query. Consequently, necessity of manually correcting the label is reduced, and the image can be recognized more easily and quickly.

The image recognition support apparatus 100 uses a mechanism such as image expansion or synonym search, and addition using the template, when making the expanded query (expanded image query, expanded language query) of the original image and the language label. Thus, the expanded query that the user cannot come up with is made. In addition, the created expanded query can exclude inappropriate images and language labels by excluding a pair of the image and the language label having a low similarity using the image language model 123.

By registering labels of the micro viewpoint and the macro viewpoint in the display switching label 140 and the attribute detail label 150, the image recognition support apparatus 100 switches a display accompanying screen switching. For example, if the labels such as “person” and “crowd” are registered on the display switching label 140 (see FIG. 3), the display switching label 427 (see FIG. 9) is switched between a case of a micro viewpoint image mainly capturing “person” and a case of a macro viewpoint image mainly capturing “crowd” in a captured video in which the view changes greatly like a captured image by the drone. This makes it possible to automatically perform simpler and more intuitive screen display.

### <<Modification: Attribute Detail for Specified Object>>

In the summarizing operation, the image recognition support apparatus 100 groups one or more objects in the region (see the region 451 in FIG. 11) specified by the user and displays the attribute detail label (see FIG. 12). The image recognition support apparatus 100 may display the attribute detail label of a partial image including one or more objects specified by the user. More specifically, the image recognition support apparatus 100 (detection result processing unit 113) generates the expanded image query 310 in which the specified partial image is set as the original image 311 (see FIG. 5). In addition, the image recognition support apparatus 100 generates the expanded language query 320 in which the attribute detected from the original image 311 using the attribute classification model 122 is set as the original text 321. Hereinafter, the image recognition support apparatus 100 can display the attribute detail label by performing steps S33 to S36 (see FIG. 7). In this way, even if the object detection model 121 fails to detect the object, the attribute detail label can be acquired.

Further, it may also be possible for the user to specify the language label for one or more specified objects or grouped objects. The image recognition support apparatus 100 performs the attribute detail label display processing (see FIG. 7) for the specified object or the grouped object and the language label, and when the average value of similarity is a predetermined value or more, the attribute detail label is displayed. In this way, the user can determine whether the label that the user has noticed is appropriate.

As described above, the expanded image query includes a partial image in the specified image.

The detection result processing unit 113 regards a plurality of specified objects as one object, and calculates the attribute detail label of the one object.

### <<Modification: Image>>

The image handled by the image recognition support apparatus 100 is not limited to a monochrome image or an RGB image, and may be, for example, an infrared image or a computer graphics (CG) image. Thus, it is possible to support image recognition in a case where satellite images and aerial images that often use thermal images, synthetic images, and the like are used. In addition, as in grasping of a disaster situation in the aerial image, even in a case where deviation in appearance frequency and the like regarding attributes is likely to occur and it is desired to give a label that is rarely used as learning data, it is possible to assign highly accurate detailed information to the attribute in the image without adding the learning data or performing manual label assignment work as much as possible.

As described above, the image is a monochrome image, a color image, an infrared image, or a computer graphics image.

### <<Modification: Expanded Image Query>>

The expanded image query in the above-described embodiment includes an image group including a region around the object. The expanded image query may be obtained by performing various image conversion processing on the image of the object. Examples of image conversion include color conversion, super-resolution, affine transformation, text removal, noise removal, and the like. In addition, processing to change the region to be detected and cut it out and the image conversion processing may be performed at the same time.

### <<Modification: Work Support Function>>

The image recognition support apparatus 100 may have a function of transmitting a work instruction (text, voice, or the like) to a photographer who is capturing an image or a worker at a capturing site. Thus, various tasks according to a recognition situation of the image can be performed. For example, appropriate disaster rescue and recovery can be performed based on the image capturing the disaster situation.

### <<Modification: Expanded Query Display Screen>>

In the region 432 of the expanded query display screen 430 (see FIG. 10), the expanded image query and the expanded language query are displayed for the object captured in the image. Instead of such a display form, the similarity (see FIG. 5) in all combinations of the expanded image query and the expanded language query may be displayed.

### <<Other Modifications>>

Although some embodiments of the present invention have been described above, these embodiments are merely examples and do not limit the technical scope of the present invention. For example, an alarm may be issued when the label (for example, “danger” or “abnormality”) specified in advance is detected among the labels included in the display switching label 140 and the attribute detail label 150, or when the similarity is a predetermined threshold or more.

The attribute detail label and the display switching label are displayed when the average value of high similarity is a predetermined value or more (see steps S34 and S35 illustrated in FIG. 7 and steps S42 and S43 illustrated in FIG. 8). The attribute detail label and the display switching label having a similarity of a predetermined value or more may be displayed.

The present invention can take various other embodiments, and various modifications such as omissions and substitutions can be made without departing from the gist of the present invention. These embodiments and modifications thereof are included in the scope and gist of the invention described in the present specification and the like, and are included in the invention described in claims and the equivalent scope thereof.

What is claimed is:

1. An image recognition support apparatus comprising:
an image acquisition unit that acquires an image;
an image recognition unit that detects an object included in the image using an object detection model; and
a detection result processing unit that generates one or more expanded image queries indicating a partial image of the image including the object, acquires a combination having a high similarity calculated using an image language model trained on a relationship between an image and an attribute including a state or situation among combinations of an expanded image query and an expanded language query indicating one or more language labels, and sets the object indicated by the expanded image query of the combination as a detected object and sets the expanded language query of the combination as an attribute detail label of the object.

2. The image recognition support apparatus according to claim 1, wherein the expanded language query includes a preset language label indicating an attribute of the object.

3. The image recognition support apparatus according to claim 1, wherein
the image recognition unit detects a language label indicating an attribute of the object using an attribute classification model, and
the expanded language query includes at least one of the language label indicating the attribute and a language label indicating a synonym of the attribute.

4. The image recognition support apparatus according to claim 1, wherein the expanded language query includes a specified language label.

5. The image recognition support apparatus according to claim 1, wherein the expanded image query includes a partial image in the image specified.

6. The image recognition support apparatus according to claim 1, further comprising a display control unit that outputs an expanded query display screen including an image indicating the expanded image query, the expanded language query, and similarity between the expanded image query and the expanded language query calculated using the image language model.

7. The image recognition support apparatus according to claim 1, further comprising a display control unit that outputs an image recognition result display screen including an image indicating an expanded image query and an expanded language query that are a combination having a maximum similarity among combinations of the expanded image query and the expanded language query related to the object.

8. The image recognition support apparatus according to claim 1, wherein the detection result processing unit calculates, as a display switching label of the image, a display switching label having a high similarity calculated using the image language model among combinations of the image and a display switching label indicating one or more language labels.

9. The image recognition support apparatus according to claim 1, wherein the detection result processing unit regards a plurality of specified objects as one object, and calculates the attribute detail label of the one object.

10. The image recognition support apparatus according to claim 1, further comprising a clustering unit that performs clustering processing on the object included in a specified region in the image and divides objects at close distances into a plurality of groups, wherein the detection result processing unit regards the group as one object, and calculates the group and the attribute detail label of the group.

11. The image recognition support apparatus according to claim 1, wherein the image is a monochrome image, a color image, an infrared image, or a computer graphics image.

12. An image recognition support method comprising:
acquiring an image;
detecting an object included in the image using an object detection model; and
generating one or more expanded image queries indicating a partial image of the image including the object, acquiring a combination having a high similarity calculated using an image language model trained on a relationship between an image and an attribute including a state or situation among combinations of an expanded image query and an expanded language query indicating one or more language labels, and setting the object indicated by the expanded image query of the combination as a detected object and setting the expanded language query of the combination as an attribute detail label of the object.
